(19) United States
(12) Patent Application Publication
(10) Pub. No.: US 2026/0040132 A1
(43) Pub. Date: Feb. 5, 2026

(54) DATA CLASSIFICATION WITHIN A FLOW

(71) Applicant: InterDigital Patent Holdings, Inc., Wilmington, DE (US)

(72) Inventors: Faris Alfarhan, Montreal (CA); Tejaswinee Lutchoomun, Montreal (CA); Ghyslain Pelletier, Montreal (CA); Tuong Duc Hoang, Montreal (CA); Francois Periard, Montreal (CA)

(73) Assignee: InterDigital Patent Holdings, Inc., Wilmington, DE (US)

(21) Appl. No.: 18/794,290

(22) Filed: Aug. 5, 2024

(51) Int. Cl. H04W 28/02; H04L 43/0829; H04L 43/0852

(52) U.S. Cl. CPC H04W 28/0268; H04L 43/0829; H04L 43/0852

(57) ABSTRACT

A WTRU receives configuration information indicating a plurality of QoS classes. The WTRU receives a data flow comprising a plurality of data units associated with characteristics. The WTRU determines a first characteristic is associated with a first data unit and a second characteristic is associated with a second data unit. The WTRU determines, based on the first characteristic, a first QoS class is associated with the first data unit, and based on the second characteristic, a second QoS class is associated with the second data unit. The WTRU determines, based the first QoS class, a first set of transmission parameters for the first data unit, and, based on the second QoS class, a second set of transmission parameters for the second data unit. The WTRU transmits the first data unit using the first set and transmits the second data unit using the second set.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described that may be associated with data classifications within a data flow. A device, which may be a wireless transmit and receive unit (WTRU), may receive configuration information indicating a plurality of quality of service (QoS) classes. Each QoS class in the plurality of QoS classes may be associated with a set of transmission parameters.

The WTRU may receive, from higher layers, a data flow comprising a plurality of data units associated with one or more characteristics. The WTRU may determine a first QoS class in the plurality of QoS classes is associated with the data flow.

The WTRU may determine a first characteristic from the one or more characteristics is associated with a first data unit from the plurality of data units and a second characteristic from the one or more characteristics is associated with a second data unit from the plurality of data units. The one or more characteristics may comprise, for example, a priority, an importance, a delay budget, a data type, or dependency on data or events.

The WTRU may determine, based on the first characteristic, the first QoS class is associated with the first data unit. The WTRU may determine, based on the second characteristic, a second QoS class is associated with the second data unit. The first QoS class may be a default QoS class and the second QoS class may be a non-default QoS class.

The WTRU may determine, based on the first QoS class, a first set of transmission parameters is associated with the first data unit, and determine, based on the second QoS class, a second set of transmission parameters is associated with the second data unit. The first QoS class may be associated with a first treatment profile and the first treatment profile may comprise the first set of transmission parameters. The second QoS class may be associated with a second treatment profile and the second treatment profile may comprise the second set of transmission parameters. The first and second set of transmission parameters may comprise one or more of a priority index, an importance level, a delay bound, a reliability level, a bit rate, or a packet loss rate.

The WTRU may transmit the first and second data units of the data flow, wherein the first data unit is transmitted using the first set of transmission parameters and the second data unit is transmitted using the second set of transmission parameters.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts a diagram of example processing of data units within a data flow.

FIG. 3 depicts an example RAN data plane architecture.

FIG. 4 depicts a diagram of example processing of data units within a data flow.

### DETAILED DESCRIPTION

A more detailed understanding may be had from the following description, given by way of example in conjunction with the accompanying drawings.

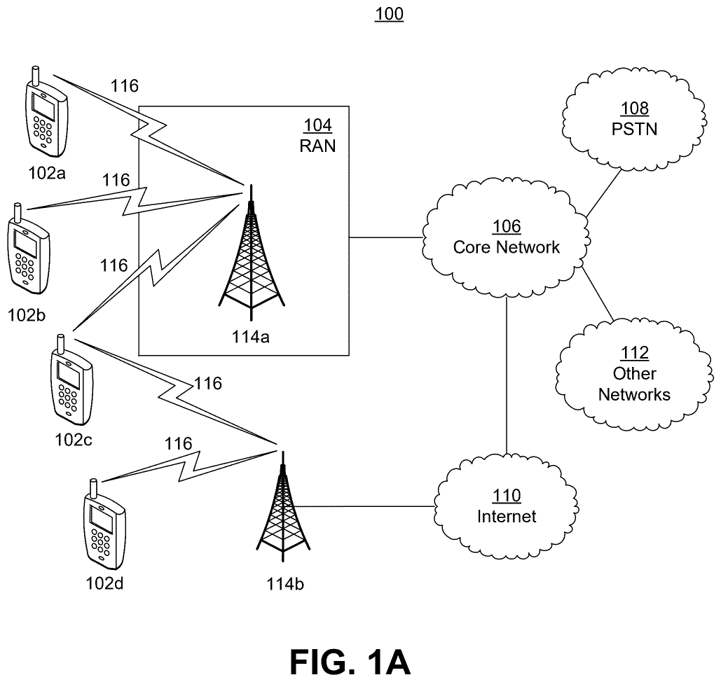

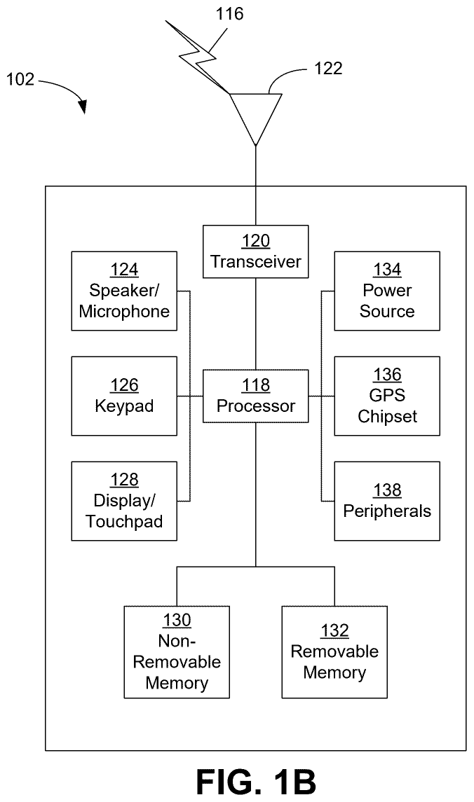

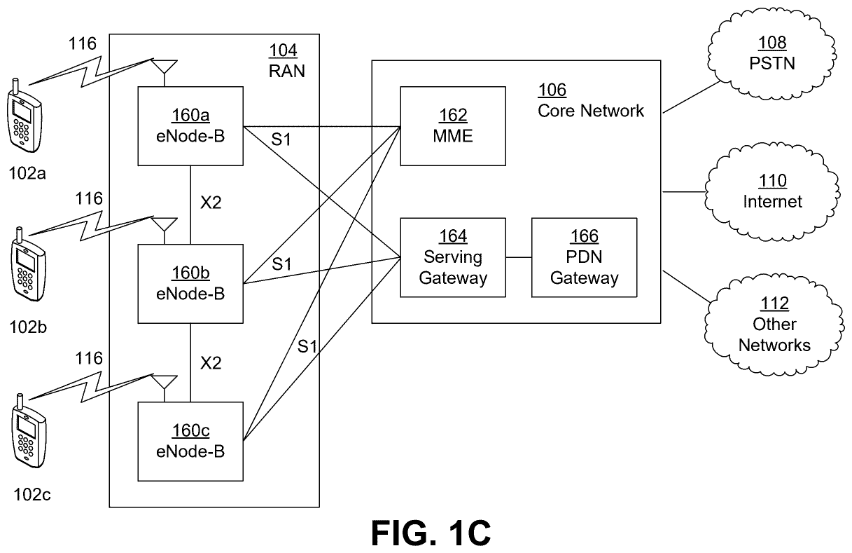

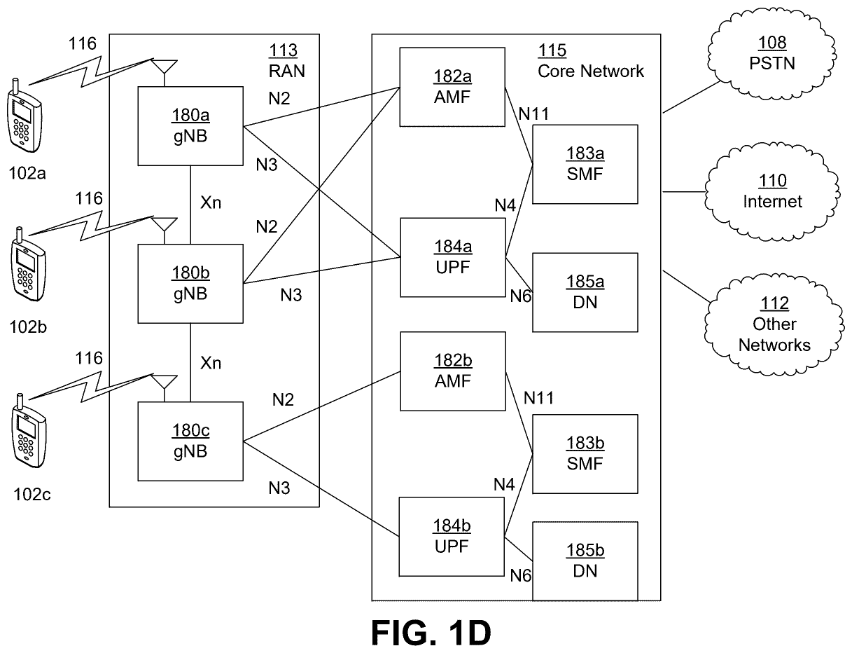

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform (DFT)-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports (e.g., only supports) a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

Disclosed herein are systems, methods, and instrumentalities associated with classifying data units within a data flow. A WTRU may receive configuration information indicating a plurality of QoS classes. Each QoS class in the plurality of QoS classes may be associated with a set of transmission parameters. The WTRU may receive a data flow comprising a plurality of data units associated with characteristics. The WTRU may determine a first characteristic is associated with a first data unit and a second characteristic is associated with a second data unit. The WTRU may determine, based on the first characteristic, a first QoS class is associated with the first data unit, and based on the second characteristic, a second QoS class is associated with the second data unit. The WTRU may determine, based on the first QoS class, a first set of transmission parameters for the first data unit, and, based on the second QoS class, a second set of transmission parameters for the second data unit. The WTRU may transmit the first data unit using the first set of transmission parameters and may transmit the second data unit using the second set of transmission parameters.

The disclosed systems, methods, and instrumentalities may relate to layer 2 (L2) data plane interfaces. A user plane interface may support effort data, e.g., best effort data, with minimum and guaranteed bit rate requirements. An L2 data plane interface may impact the following: computational efficiency; QoS, latency, and reliability; support of different data types; WTRU and network power consumption; scheduling, capacity, and congestion; and application layer awareness.

An L2 data plane interface may impact computational efficiency. L2 processing may scale linearly with packet rate. As the packet rate increases, it may significantly boost processing demands and power consumption, creating overhead challenges for both the network and the WTRU. Layering of L2 protocols may create an overly hierarchical structure leading to manufactured latencies and increased computational complexity.

An L2 data plane interface may impact QoS, latency and reliability. An L2 interface may support a variable QoS requirement, low latency, and/or high reliability, which may be associated with applications, e.g., extreme applications, including, for example, XR, VR, AR, HRLLC, eURLLC. Retransmissions may be duplicated in multiple layers. Retransmissions at higher layers (e.g., RLC) may be slow, e.g., too slow to meet latency sensitive applications (e.g., XR). Retransmissions may be rigid, e.g., too rigid (e.g., retx data may be the same, e.g., exactly the same, have a same TB size, and have a same carrier, etc.). QoS attributes may be assigned to each data set/channel, including KPIs (e.g., Priority, PBR, PDB, PER, BLER), and additional KPIs (PDSB, dependencies to other sets, strict delay, energy consumption, complexity metrics). An L2 interface may enable elastic QoE level varying (e.g., between the min data rate/GBR and max data rate), though QoS is met. QoE may meet, e.g., must meet, a min requirement. For example, the WTRU may start transmission of data with a given QoE level that is higher. Then, as the WTRU moves out of coverage, experiences cell congestion, or if/when data rate drops, the WTRU may then reduce the QoE level or reduce the number of data packet sets that may be transmitted. For example, if there are multiple/multi-modal streams, the WTRU may drop one stream that may or may not be necessary to meet the min QoE level while still maintaining the QoS.

An L2 data plane interface may impact support of different data types. SRB and DRB data may be differentiated, and treatment of UP data QoS may be controlled by QoS flow to DRB mapping. Once mapped to a DRB, packet treatment may be done semi-statically. New applications (e.g., AI/ML, XR, sensing, volumetric video) may introduce new data types, potentially within a QoS flow. NR UP may or may not provide differentiated treatment for more important/systematic packets (e.g., for a QoS flow). Data sets may be classified by type (e.g., control, data, sensory, AI/ML data). The L2 interface may, therefore, support means to avoid unnecessary data transmission, and handling of QoS/QoE dependencies between different data types (e.g., UP, CP, system data) and dependencies between data of the same type.

An L2 data plane interface may impact WTRU and network power consumption. The L2 protocol may enable both WTRU and network power savings. DRBs may or may not be elastic in terms of resource allocation and mapping across cells and cell groups. The L2 interface may, therefore, support means for timely WTRU reachability, WTRU processing chain power consumption, and/or balancing network and WTRU energy consumption. A PDU may (e.g., should) be able to be transmitted/received in a more dynamic manner, without rigid restrictions on DRB, carrier, or cell group.

An L2 data plane interface may impact scheduling, capacity, and congestion. Configured grants may be responsive to delay bounds but may consume overhead, e.g., heavy overhead. Transmission on dynamic grants following SR/BSR may incur delays. LCP may be based on leaky bucket uplink traffic shaping, and may or may not consider inter-packet associations, latency bounds, or congestion.

An L2 data plane interface may impact application layer awareness. NR UP may or may not provide differentiated treatment for more important packets. Relevance may vary over time or over other control reception, e.g., within a bearer. Several applications may generate packets that have different importance. L2 protocols may or may have not evolved with new application layer transport protocols (e.g., QUIC developed for faster, more reliable, and more efficient data transfer). Awareness may include RAN being aware of application QoS and QoE metrics/data (e.g., events, important/relevant data) and the application being aware of RAN dynamic conditions (e.g., radio conditions, congestion, cell load, etc.). The application itself may adjust the rate of the packet set, and in such case the WTRU may or may not change the underlying QoE level (e.g., when the video rate is decreased by the application). This may mean that the WTRU may or may not be aware of the application layer (e.g., no awareness in the first case, but awareness in the second case). Awareness may also involve awareness of application flow dependencies, synchronization, and other system data (e.g., sensory, ML, CP triggered events such as, for example, handover, etc.).

Systems, methods, and instrumentalities may be employed to enable an inclusive data plane architecture that supports different data types, data dependencies, packet differentiation (e.g., RAN treatment) within a given flow.

User plane architectures/frameworks may or may not consider the following: packet priority within a data flow; inter-packet associations; different data types and dependencies; latency bounds; congestion; PDU burst sizes; and prioritization.

User plane architectures/frameworks may or may not consider packet priority within a data flow. For example, user plan architectures/frameworks may or may not consider how to handle higher priority packets within a given data flow with semi-statically configured priority for UL resource allocation. LTE/NR user plane protocol may provide a good framework for meeting minimum data rate requirements. Packets may be buffered per DRB/LCH and then may be transmitted in a FIFO fashion (e.g., by order of SN). Within a given data set mapped to a LCH, all packets may be treated equally. This may or may not be favorable for some applications (e.g., volumetric video where some frames provide means to produce an image of the overall picture; higher layer error encoded PDU sets with some carrying more systematic/important bits for decoding the overall set; or a gated transmission where if a given PDU x within a set is not transmitted, follow up PDUs with index greater than (>) x are useless to the application, etc.).

User plane architectures/frameworks may or may not consider inter-packet associations. For example, user plane architectures/frameworks may or may not consider how to enable handling differentiation among packets of the same flow when allocating UL resources. A set of PDUs (e.g., frames from a given video service, PDUs from an AR/XR PDU set, PDUs from a set of error coded PDU set, etc.) may be modelled as a given QoS flow mapped to a given DRB, where the DRB may be associated with a given LCH. Such a LCH may have one global priority from an LCP perspective, and thus certain packets/PDUs from a PDU set may or may not be differentiated (e.g., a system video frame) and also SDUs, e.g., all SDUs, belonging to the same LCH thus may have the same priority.

User plane architectures/frameworks may or may not consider different data types and dependencies. For example, user plane architectures/frameworks may or may not consider how to enable handling of data dependencies if/when allocating UL resources to competing flows. Flows may be associated with, for example, CP, UP, sensory, and/or AI/ML. SRB and DRB data may be differentiated, and treatment of UP data QoS may be controlled by QoS flow to DRB mapping. Once mapped to a DRB, packet treatment may be done semi-statically. Applications, e.g., new applications (e.g., AI/ML, XR, sensing, volumetric video) may introduce data types, e.g., new data types, potentially within a QoS flow. NR UP may or may not provide differentiated treatment for more important/systematic packets (e.g., for a QoS flow). There may be a possibility that there may be system data assumed in addition to control plane and user plane (e.g., service data) but also that there may be dependencies to manage between not only data of the same service, but also between UP data (e.g., an XR service that has AR, or a subset of the data such as AR objects, metadata for scene description and/or updates thereof) and system data (e.g., sensing of real objects and position to help anchor the AR objects coherently with the real world), or with CP data e.g., in case of mobility triggers that initiate from sensing activity that is associated with mobility (e.g., events and measurements that aim to detect blockage). An example of dependency within a packet data set may be an FEC encoded set, where it may be useful to, e.g., may be necessary to, decode X out Y encoded PDUs to decode the overall data set.

User plane architectures/frameworks may or may not consider latency bounds. For example, user plane architectures/frameworks may or may not consider how to support delay-aware UL resource allocation while maintaining fairness to other competing flows. In NR and LTE, allocation of buffered UL data may be performed based on priority-first and prioritized bit rates. In cases of congestion, some data flows may face starvation, especially when high priority flows have much higher PBRs. This may cause lower priority data flows to miss their delay bounds.

User plane architectures/frameworks may or may not consider congestion. For example, user plane architectures/frameworks may or may not consider how to avoid starvation of UL data flows when allocating resources and/or how to handle congestion within the UE when multiple flows are competing for UL resources. There may be congestion from a WTRU's perspective, where higher priority PDUs may be transmitted, and lower priority ones may not be transmitted at all. Such packets may eventually be discarded if/when higher importance packets may be available for transmission. It is generally not favorable to discard data unless really needed, to avoid data loss. During such congestion conditions, some lower priority data flows may face starvation.

User plane architectures/frameworks may or may not consider PDU burst sizes. For example, user plane architectures/frameworks may or may not consider how to enable UL data burst transmission without delay.

User plane architectures/frameworks may or may not consider prioritization between transmission of new data and reconstructed retransmitted data.

Systems, methods, and instrumentalities may be provided for data unit QoS classification within a data flow, e.g., a RAN data flow.

A WTRU may be configured with a plurality of QoS classes, wherein each class may be associated with one or more RAN QoS treatment profiles. Each data flow may be configured with at least one default QoS class. For each data unit within a RAN data flow (e.g., a data unit set), the WTRU may associate a RAN QoS class as function of the data unit (e.g., the data unit's associated priority, importance, delay bound, data type, and/or dependency to other data or control plane events).

The WTRU may be configured with a plurality of QoS classes that may be used for QoS/QoE handling within the RAN protocol stack. Each QoS class may be configured, or associated with, a RAN QoS treatment profile which may contain a number of parameters (e.g., in various protocol chain layers) for differentiating QoS and/or QoE.

For each RAN data flow (e.g., a data unit set) received from upper layers, the WTRU may be configured with a default QoS class.

For each data unit within the RAN data flow (e.g., a data unit set), the WTRU may associate (e.g., associate with the data unit) a RAN QoS class.

If a condition for assigning a differentiated QoS class is met for the data unit (e.g., based on the data unit's priority, importance, delay bound, data type, and/or dependency to other data or control plane events), the WTRU may assign (e.g., associate with the data unit) a non-default QoS class which may be configured for the data flow.

If a condition for assigning a differentiated QoS class is not met (e.g., based on the data unit's priority, importance, delay bound, data type, and/or dependency to other data or control plane events), the WTRU may assign (e.g., associate with the data unit) the default QoS class configured for the data flow.

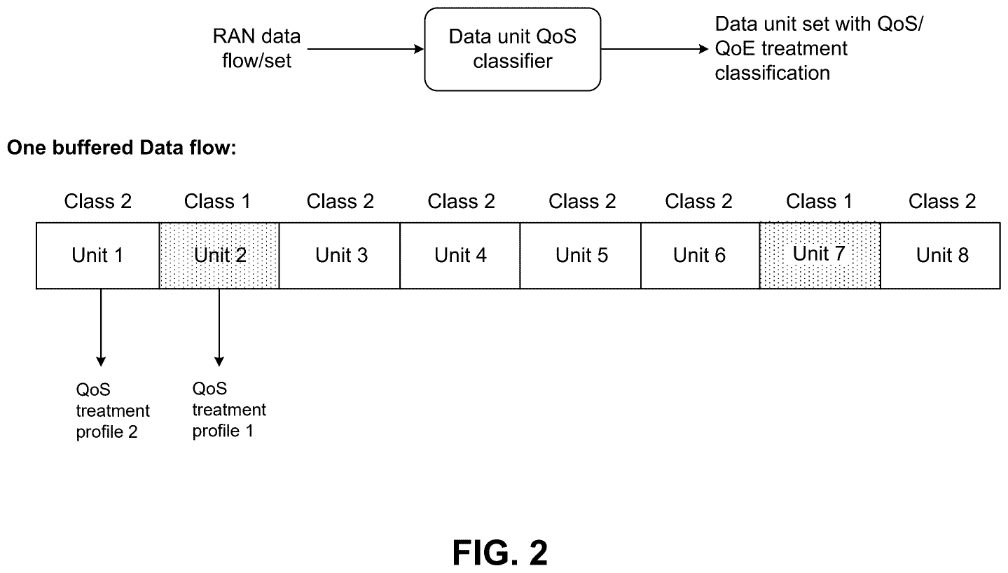

FIG. 2 is a diagram depicting example processing of data units within a data flow. As shown in the upper portion of FIG. 2, a data flow or data set, which may be associated with transmission over a RAN, may be received at a data unit QoS classifier. The data unit QoS classifier, which may be implemented in a WTRU, may be configured to determine QoS classifications for data units in a received data flow. A data flow may be received, and the data unit QoS classifier may generate a data unit set with QoS/QoE classifications assigned to or associated with data units in the set.

The data unit QoS classifier may determine a plurality of QoS classifications and apply the classifications to data units in a flow. The plurality of QoS classes may be received in configuration information. Each of the data units in a data flow may be associated with respective characteristics. For example, each data unit may be associated with one or more of a priority, an importance, a delay budget, a data type, or dependency on data or events. A first data unit may be associated with one or more characteristics and a second data unit may be associated with one or more characteristics. The QoS classifier may determine for each data unit a QoS class based on the characteristics associated with the respective data unit. The data unit QoS classifier may associate a first QoS classifier based on the one or more characteristics associated with the first data unit. The data unit classifier may associate a second QoS classifier based on the one or more characteristics associated with the second data unit.

As shown in the lower portion of FIG. 2, one data flow may comprise multiple data units including unit 1 through unit 8 as depicted. The QoS classifier may evaluate the characteristics associated with each data unit and associate a QoS class with each unit. As shown, data unit 2 and data unit 7 are assigned QoS class 1, while the remaining data units (1, 3-6, and 8) have been assigned class 2. The QoS classes are assigned to the data units based on the characteristics associated with the respective data units.

The QoS classes may be associated with a respective treatment profiles. The treatment profiles may comprise one or more parameters such as, for example, a priority index, an importance level, a delay bound, a reliability level, a bit rate, or a packet loss rate. The WTRU may determine transmission characteristics for the particular data unit based on the parameters comprised in or associated with the treatment profile.

Gated data sets may be employed. A gated traffic data flow may be defined as a data set, where there is a subset of “gating PDUs” and non-gated PDUs. Transmission of a gating PDU may enable the transmission of non-gating PDUs. PDUs in a gated data set may be periodic.

If PDU x arrives every y ms (microseconds), and PDU x is a gating systematic PDU that enables a gated transmission, PDU x+1 may not be transmitted if PDU x is not transmitted or if PDU x is not deemed to be transmitted successfully (e.g., acknowledged). In one example, if PDU x arrives/or is transmitted at time instance t, PDUs (e.g., all PDUs) between t and t+y may not be transmitted unless PDU x is transmitted or transmitted successfully.

An example of gated data sets may apply to video traffic with systematic frames. Some video applications may not benefit from transmission of frames following a systematic frame, as the picture may not be complete without it (e.g., a systematic frame may be, e.g., should be, fully transmitted before transmission of subsequent frames).

Channel conditions may impact processing. Channel conditions may relate to the state of the radio/channel, which may be determined by the WTRU from one or more of the following: a WTRU measurement (e.g., L1/SINR/RSRP, CQI/MCS, channel occupancy, RSSI, power headroom, exposure headroom); L3/mobility-based measurements (e.g., RSRP, RSRQ, s-measure); an RLM state; and/or channel availability in unlicensed spectrum (e.g., whether the channel is occupied based on determination of an LBT procedure or whether the channel is deemed to have experienced a consistent LBT failure).

A property of scheduling information (e.g., an uplink grant or a downlink assignment) may consist of at least one of the following: a frequency allocation; an aspect of time allocation, such as time instance or/and a time duration; a priority; a modulation and coding scheme; a transport block size; a number of spatial layers; a number of transport blocks to be carried; a TCI state or SRI; a number of repetitions; or whether the grant is a configured grant or a dynamic grant.

An indication, e.g., an indication by DCI, may consist of at least one of the following: an explicit indication by a DCI field or by RNTI used to mask CRC of the PDCCH; an implicit indication by a property such as DCI format, DCI size, Coreset, search space, aggregation level, identity of first control channel resource (e.g., index of first CCE) for a DCI, where the mapping between the property and the value may be signaled by RRC or MAC; or an explicit indication by a DL MAC CE.

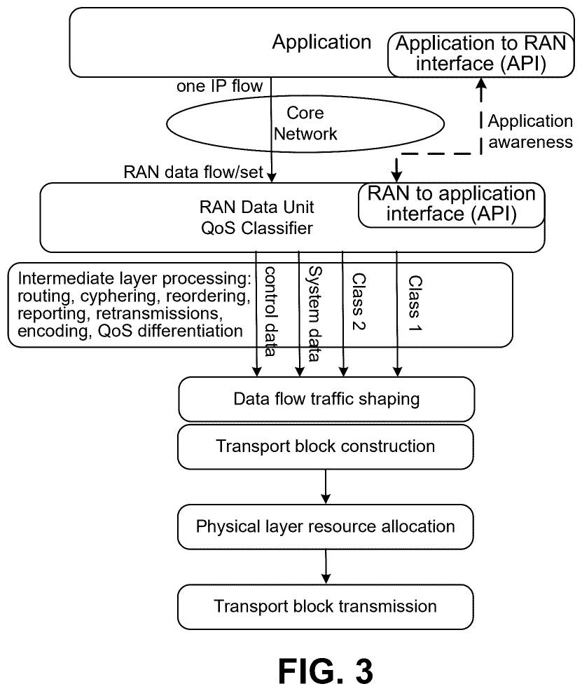

Classification of data units in a data flow may be applied in a RAN data plane architecture. FIG. 3 depicts an example RAN data plane architecture.

As depicted in FIG. 3, in an example data plane architecture framework, an application may provide one or more IP flows for transmission over a medium. Each IP flow may then go through a transport layer protocol (e.g., TCP/IP, QUIC, RTP, MOC, etc.). Each IP flow (e.g., a PDU session) may go through a RAN core network, which may map it to a RAN data flow or a RAN data set. For each RAN data flow, the core network may attach QoS requirements, a QoS metric, and/or a range of QoE metrics.

A RAN data flow may represent a logical association between data packets and/or units, e.g., originating from the same IP flow. Such an association may be based on data units being associated with the same IP flow, application flow, or having the same association packet marked either by the core network or the application.

RAN data flows may or may not originate from a user application, but rather from a control plane (e.g., control data and RAN signaling and configurations), an intelligence plane (e.g., data collected from AI/ML services), a computing plan (e.g., used for native computing for computing services), a system plane (e.g., data originating within the RAN due to, for example, sensing or positioning services), and/or a security plane.

As depicted in FIG. 3, an application to RAN interface (App API) may reside within the application to indicate one or more indications to the RAN, e.g., for differentiated QoS treatment for one or more packets. The RAN may then adapt its QoS treatment (e.g., by adapting reliability level, data rate, and/or latency treatment), once an indication is received from the application API. The WTRU may be able to determine one or more property of the application data or control signaling from a relay on top of the RAN protocol stack, which may be used to de-cypher and decrypt the transport layer and/or application content if encrypted.

As depicted in FIG. 3, a RAN to application interface (RAN API) may reside within the WTRU RAN protocol stack to communicate one or more indications to the application layer, e.g., to notify the application of changing RAN conditions (e.g., a change in RF conditions, a decrease or increase in achievable data rate, reporting of congestion at the UE for UL traffic or at the cell for DL traffic, channel conditions such as, for example, RSRP or headroom, being lower than a threshold, etc.). The application may then adapt its service (e.g., data rate, reliability level, FEC, delay bound) according to the indication(s) received from the RAN API.

A data unit, as described herein, may comprise, e.g., consist of, any one or more of: a bit and/or group thereof; a byte and/or group thereof; a PDU segment and/or group thereof; a PDU; a group/set of PDUs (e.g., PDU set); a set of PDUs considered as one unit at the application, e.g., set of PDUs corresponding to a frame; a group of PDU sets; a data burst; and/or a group of data burst.

A data unit may be within one RAN data flow/set or may span across multiple RAN data flows/sets. In examples, a data unit may be constructed at the application and may be sent to the WTRU as such. In examples, a data unit may be constructed at the WTRU, e.g., at the RAN data unit QoS classifier as described herein.

IDs/identifiers may be associated with a data unit and/or component/group/type thereof. In examples, the IDs may be allocated by the application. In examples, the IDs may be allocated by the WTRU, e.g., by the RAN data unit QoS classifier as depicted in FIG. 3. For example, new identifiers may be used allowing both transmitter and receiver to exchange feedback on the data units. Existing identifiers may be used such as sequence numbering at PDCP. Existing identifiers such as sequence numbering at PDCP may be updated to incorporate the concept of data units. For example, sequence numbering (1,1), (1,2), (1,3) at PDCP may refer to packets 1, 2, 3 of data unit 1. The WTRU may receive rules on how to allocate identifiers to the data units and/or its constituents from the network, e.g., during RRC (re) configuration. The WTRU may receive rules/configuration, e.g., during RRC (re) configuration, on how to translate identifiers for the data units and/or its constituents that may have been allocated/received from higher/application layer to an identifier that is understandable to/decodable by the network. For example, the WTRU may receive rules on how to create an identifier. The WTRU may receive a mapping table on how to map an application-created identifier to an identifier that the network understands. The WTRU may receive rules on how to update an identifier.

Data unit grouping may be employed. The WTRU may be configured such that it may determine relationships between different data units. Such relationship may be based on a matching function, e.g., based on the configuration of one or more field values common to data units that are part of the same logical association. Such fields may correspond to fields in a protocol header associated with the data unit(s) or the QoS class. For example, such a matching function may use several parameters for fields of the IP headers of the data unit such as IP source/destination address, transport protocol source/destination ports, and/or transport protocol type. For example, data units that are part of the same data flow may share a common identifier assigned by the QoS classifier, by a start and an end marker, or by configured association. Grouping data flows may be a function of sequence numbering of the IP flow.

A RAN data flow may be constructed by grouping packets of the same IP stream, where such grouping is based on one or more criteria. The WTRU may maintain a data backlog buffer for each data flow, data unit set, or set of data units associated with the same QoS class. Logical grouping may be applied per such buffering logic used.

Data units associated with a data flow may be simplified to PDUs within a DRB. If all PDUs are associated with the same QoS class, all PDUs in that DRB may be mapped to a logical channel in lower layers.

The WTRU may propagate data units of a data flow to lower layers with a QoS class, which is then used to determine how to treat and differentiate QoS/QoE at various lower layers, possibly without rigid association to a given set of radio resources (e.g., a DRB, a cell group, or a carrier). Data units can thus be treated elastically in lower layers without restrictions on cell groups, carriers, or a given set of radio resources.

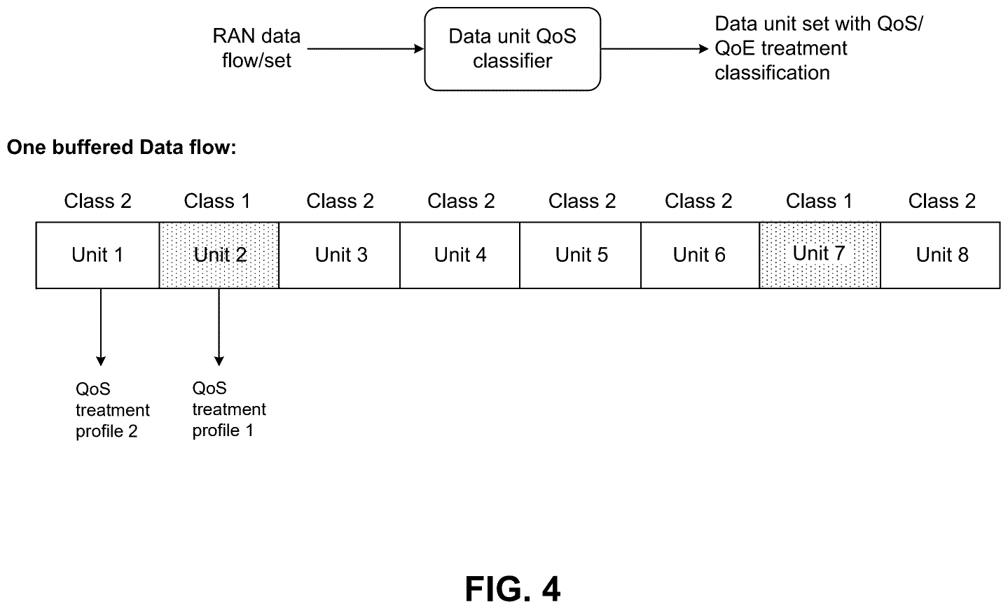

QoS classes may be assigned to data units within a data flow. FIG. 4 depicts example data unit classification.

A WTRU may receive configuration information indicating a plurality of quality of service (QoS) classes. Each QoS class in the plurality of QoS classes may be associated with a set of transmission parameters.

As depicted in FIG. 4, the WTRU, e.g., the data unit QoS classifier, may receive, from higher layers, a data flow comprising a plurality of data units associated with one or more characteristics. The WTRU may determine a first QoS class in the plurality of QoS classes is associated with the data flow.

A WTRU may assign a QoS class to each data unit within a RAN data flow for the purpose of characterization of how data should be transmitted. Such characterization may represent constraints and/or requirements that the WTRU may be expected to meet and/or enforce. The WTRU may perform different operations and/or adjust its behavior as a function of the state associated with the data based on such characterization.

Instead of mapping a RAN data flow to a radio bearer (e.g., DRB), the data protocol plane may contain a data unit classification function for QoS/QoE marking throughout the protocol chain. The QoS/QoE class may be determined in such a layer according to one or more configured or predefined rules. Such QoS classes may be used in various layers within the data plan protocol chain for achieving a certain QoS requirement and/or a QoE level.

The WTRU may determine a first characteristic from the one or more characteristics is associated with a first data unit from the plurality of data units and a second characteristic from the one or more characteristics is associated with a second data unit from the plurality of data units. The one or more characteristics may comprise, for example, a priority, an importance, a delay budget, a data type, or dependency on data or events.

The WTRU may determine, based on the first characteristic, a first QoS class may be associated with the first data unit. The WTRU may determine, based on the second characteristic, a second QoS class may be associated with the second data unit. The first QoS class may be a default QoS class and the second QoS class may be a non-default QoS class.

As depicted in FIG. 4, data units of the same data flow may or may not have the same QoS class. In examples, e.g., I-frames of a video stream, a higher QoS class may be given to such PDUs, while other frames (e.g., P-frames) may be given a lower QoS/QoE class, even though both data units may belong to/are grouped in the same data flow.

A QoS class may be an indicated part of a protocol layer header. In examples, the QoS class may not be propagated in a header to lower layers, but rather maintained by the WTRU and communicated (e.g., within the WTRU) to lower layers.

As depicted in FIG. 4, the WTRU may determine, based on a first QoS class, a first set of transmission parameters is associated with a first data unit, and determine, based on a second QoS class, a second set of transmission parameters is associated with a second data unit. The first QoS class may be associated with a first treatment profile and the first treatment profile may comprise the first set of transmission parameters. The second QoS class may be associated with a second treatment profile and the second treatment profile may comprise the second set of transmission parameters. The first and second set of transmission parameters may comprise one or more of a priority index, an importance level, a delay bound, a reliability level, a bit rate, or a packet loss rate.

Using QoS treatment profiles, for each QoS class assigned to data units within a data flow, a specific set of processing steps and/or a specific set of functions may be applied to the data that may affect one or more transmission characteristics over the radio interface, in one or more layers in the protocol chain.

Each QoS class may be associated with a QoS treatment profile in the RAN, which may be configured semi-statically. Each QoS treatment profile may contain a number of parameters to control the RAN treatment of the data transmission/reception and a number of metrics to achieve the QoE level for a given layer in the protocol chain.

Such parameters may include, but are not limited to, time-related aspects such as a delay bound for a packet, which may represent the time before which the packet may be, e.g., should be, transmitted/acknowledged to meet the QoS requirement and/or data rate-related aspects. Such parameters may also be changed with time while the packet or data is pending for transmission.

Each QoS class or QoS treatment profile may be associated and/or configured with one or more of the following: a priority index; an importance level; a delay bound; a reliability level; a guaranteed bit rate; a maximum bit rate; and/or a maximum packet loss rate.

A priority index may comprise a priority value for QoS treatment at UP and AN functions. It may correspond to scheduling priority, or handling in case of congestion. The priority value may also indicate whether the data unit requires guaranteed bit rate and/or maximum flow bit rate.

An importance level may define the flow relative importance to access to AN resource. The importance level may indicate, e.g., may also indicate, whether the access to AN non-prioritized resource may be pre-emptiable and resources allocated should be protected from pre-emption and whether the data unit can be discarded or deprioritized (e.g., remains buffered) for transmission.

A delay bound may be, for example, the max time before which the data unit may be transmitted or acknowledged to meet latency QoS/QoE requirements.

A reliability level may determine the number of repetitions, duplication, MCS selection, FEC encoding level, and/or physical layer characteristic that determines a reliability level (e.g., a BLER requirement or a HARQ operating point).

Each data flow may be associated and/or configured with one or more of the following: an expected burst volume; a maximum data burst volume (which may represent the largest amount of data that the access network may be required to serve for a given flow within a period of PDB, which period may correspond to the delay of the data while in the access network itself); a periodicity between data bursts; a start and/or an end of data burst indication/field; a range of QoS classes applicable; a jitter range and inter-packet delays; a range of QoE levels; and a range of supported data rates.

QoS marked data units from a data flow may then propagate to lower layers and differentiated QoS handling may be performed (e.g., per the QoS treatment profile associated with the QoS class) in various functional components of different layers. For example, a WTRU may transmit a first and second data units of a data flow, wherein the first data unit is transmitted using a first set of transmission parameters associated with a first treatment profile and the second data unit is transmitted using a second set of transmission parameters associated with a second treatment profile.

A data unit QoS classifier may implement conditions in connection with associating classes with data units in a data flow. The data unit QoS classifier may employ conditions and rules to associate classification of packets within a data flow.

A WTRU may use a procedure to classify UL data units (e.g., packets within a data flow, SDUs, PDUs within a PDU set) on a dynamic basis, where a data unit may be assigned with a QoS class if it meets one or more conditions.

If a condition for QoS classification may be met, the WTRU may assign a certain QoS class value to a given data unit, which may or may not be the default QoS class. The WTRU may be configured with a default QoS class, which may be preconfigured semi-statically for the whole data flow. If no special classification conditions are met, the WTRU may classify a data unit from such flow with the configured default QoS class for the data flow. The WTRU may be configured or predefined with one or more non-default QoS class(es), where there is a mapping between a given QoS class and a condition for QoS classification. If the conditions are met, the WTRU may associate the data unit with the non-default QoS class.

Conditions for QoS classification may include one or more of the following: packet priority; packet importance; packet delay budget; data type; reception of an indication from an application or RAN API; reception of an indication from a network overriding a configured default QoS class; reception of an indication for a given grant; data from a gating set; a function of dependent data or data set; a function of systematic PDU within a set; satisfaction of one or more control plane events; sensing an object or determining an outcome from a sensing or positioning procedure; dropping or adding one or more data flows; synchronization between data flows; dropping or adding one or more dependent data types; satisfying one or more vents from a transport layer protocol; measuring a channel condition below or above a threshold; a function of whether the data unit is transmitted initially or retransmitted; a function of energy saving state of the network; and/or transmission or determination of a successful transmission; reception of a dependent data unit on a sidelink.

Conditions for QoS classification may comprise packet priority. Packet priority may serve as a condition, for example, based on the possibility of transmission/inclusion of buffered data from a subset of PDUs within a PDU set, where such PDUs may be configured or predetermined to be of higher priority, a lower delay bound, or high QoS treatment profile compared to other PDUs within the set. If the data unit is of higher priority, the WTRU may associate a data unit with a given QoS class. If the data unit is of lower priority, the WTRU may associate data unit with another QoS class.

Conditions for QoS classification may comprise packet importance. The packet importance may serve as a condition, for example, based on the possibility of transmission/inclusion of buffered data from a subset of PDUs within a PDU set, where such PDUs may be configured or predetermined to be of higher importance compared to other PDUs within the set, where importance may be a value obtained from an indication from the core network packet profile, the application interface, or from the service characteristics (e.g., the period of the packet or the type of packet associated with it. If the data unit is of higher importance, the WTRU may associate a data unit with a given QoS class. If the data unit is of lower importance, the WTRU may associate a data unit with another QoS class.

Conditions for QoS classification may comprise a packet delay budget. A packet delay budget may serve as a condition, for example, based on the possibility of transmission/inclusion of buffered data from a subset of PDUs within a PDU set, where the remaining time until the delay budget for the PDU or the underlying application may be less than a threshold. If the delay budget is less than a threshold, the WTRU may associate the data unit with a given QoS class.

Conditions for QoS classification may comprise a data type. A data type may serve as a condition, for example, based the possibility of inclusion of data from a given type, e.g., AI/ML, XR, sensing, volumetric video. For example, for a data unit containing AL/ML data, the WTRU may associate a data unit with a given QoS class. For a data unit containing sensing data, the WTRU may associate data unit with another QoS class.

Conditions for QoS classification may comprise reception of an indication from the application or the RAN-application interface (API). The application may indicate that for a given data unit, a differentiated QoS class may be, e.g., is to be, associated. The Indication may provide a given QoS class, or an identifier associated with it. The WTRU may be configured with a given non-default QoS class to apply to a data unit once an indication/flag is received from the API for such data unit. For example, upon reception of an indication from higher layers (e.g., from application) indicating that such packet needs to be prioritized ahead of other buffered packets in the queue for such data flow, the WTRU may associate a different (e.g., non-default) QoS class to the data unit.

Conditions for QoS classification may comprise reception of an indication from the network overriding a configured default QoS class for one or more data flows. The Indication may include a given QoS class to apply, possibly for a period of time. Such an indication may be determined as a function of a property of the scheduling information (e.g., in the DCI) or an indication by DCI.

Conditions for QoS classification may comprise reception of an indication for a given grant. A DCI may signal a given QoS class. For such a QoS class, data, e.g., only data, associated with such a class may be multiplexed. The WTRU may, e.g., may alternatively, multiplex data regularly on the grant then treat the whole TB as data with the signaled QoS class (e.g., in lower layers). Such an indication may be determined as a function of a property of the scheduling information (e.g., in the DCI) or an indication by DCI.

Conditions for QoS classification may comprise data from a gating data set. A WTRU may associate a given non-default QoS class to a gating data unit.

Conditions for QoS classification may comprise a function of dependent data or a data set. For a data unit that other units depend on (e.g., an FEC source packet, a video defining frame, e.g., I frame, a gating data unit) a non-default (e.g., prioritized) QoS class may be assigned or associated with a data unit. For dependent, duplicated, or redundant data units, a different QoS class may be assigned (e.g., a default QoS class associated with the flow).

Conditions for QoS classification may comprise a function of a systematic PDU within a set. A QoS class may be assigned depending on the possibility of transmission/inclusion of buffered data of a systematic frame/data unit within a data flow (e.g., source data units that are encoded, systematic video frames, etc.).

Conditions for QoS classification may comprise satisfying one or more control plane event. For example, a QoS class may be assigned depending on satisfying one or more mobility event condition, or satisfying a conditional handover condition to one or more handover candidate. For example, upon satisfying a mobility, an RLM, a beam failure, or an RLF, the WTRU may associate a different QoS class with a data unit, possibly for a period of time associated with the CP event.

Conditions for QoS classification may comprise sensing an object or determining an outcome from a sensing or positioning procedure. For example, sending data may be configured or pre-associated with a given QoS class. Upon detection of an object as a function of sensing or a spatial computing service as an outcome of sensing, the WTRU may select a certain QoS class (e.g., non-default or configured QoS class).

Conditions for QoS classification may comprise dropping or adding one or more data flows. For example, upon adding or dropping one or more service or a data flow (e.g., from a multi-modal service or session), the WTRU may change the QoS class associated with the remaining data flow or dependent data flow.

Conditions for QoS classification may comprise synchronization between data flows. For example, if synchronization between data flows is configured or indicated from the application or the core network, the WTRU may associate one QoS class for data units if/when a dependent data flow is synchronized and another QoS class if/when the data flow is not synchronized or within a period of miss-synchronization (e.g., a remaining synch time is larger or lower than a threshold). If a common identifier is used (e.g., signaled from the application or the core network) to associate two flows, the WTRU may use the same QoS class for data units of both data flows. Once dissociated, the WTRU may revert to the default QoS classes configured for each data flow individually.

Conditions for QoS classification may comprise dropping or adding one or more dependent data types. If the WTRU is configured to need X out of Y data units to decode an overall packet (e.g., an FEC encoded packet, a source video frame, etc.), the WTRU may select a given QoS class when X out Y have been successfully decoded. The WTRU may associate a different QoS class when X out of Y have not been successfully decoded and/or if X′ out of Y units have been received, and/or if X″ units have been not acknowledged but received.

Conditions for QoS classification may comprise satisfying one or more event from the transport layer protocol (e.g., generating TCP ACK, transmission of an out of order packet within a transport protocol session/connection, reading a specific value from the header of the transport layer protocol for a given packet). If such condition is met, the WTRU may associate the associated data unit of the related RAN data flow with a given QoS class. The WTRU may be able to determine one or more property of the transport layer protocol from a relay on top of the RAN protocol stack, which may be used to de-cypher and decrypt the transport layer header and/or content if encrypted.

Conditions for QoS classification may comprise measuring a channel condition below or above a given threshold, or measuring a change in the channel conditions below or above a given threshold. Once such condition is met, the WTRU may associate a data unit with a given QoS class.

Conditions for QoS classification may comprise a function of whether the data unit is transmitted initially or retransmitted (or as a function of the retransmission number).

Conditions for QoS classification may comprise a function of the energy saving state of the network (which may be indicated to the WTRU) or the power saving state of the WTRU (e.g., whether DRX is used).

Conditions for QoS classification may comprise transmission or determination of successful transmission of dependent data types or a dependent data unit (possibly only from the same data flow or from a different data flow). For example, if a data unit x is successfully transmitted, a WTRU may determine QoS class B for data unit y. If a data unit x is not successfully transmitted, the WTRU may determine QoS class A for data unit y. y may be, for example, x+1. Data unit y may be a UL or a DL data unit.

Conditions for QoS classification may comprise reception or successful reception of a dependent data unit on the downlink (e.g., on a PDSCH), possibly only from an associated data flow by configuration. For example, if a DL data unit x is successfully received, the WTRU may determine QoS class B for UL data unit y. If a DL data unit x is not successfully received, the WTRU may determine QoS class A for UL data unit y.

A condition for QoS classification may be bound for a period of time, e.g., once satisfied, it is considered satisfied until the period of time (configured or predetermined) has elapsed. While the condition is met during the period of time, a differentiated QoS class applies to the data unit. Once the period expires, the data unit is associated with a default QoS class or a reverted QoS class that was assigned before the condition was met.

A condition may be bound to a subset of data flows (e.g., a QoS flow, data unit set, a DRB, LCH, LCG, PDU set, etc.). Once satisfied, the WTRU may determine that it is applied for, e.g., only for, the applicable set of data flows (which may be configured by higher layer signaling) and the associated QoS class is applied for the data unit.

A condition may be bound to a subset data types (e.g., control, user data, system data, intelligence data (AI/ML), positioning data, sensing data). Once satisfied, the WTRU may determine that it is applied only for the applicable set of data type (which may be configured by higher layer signaling) and the associated QoS class is applied for the data unit.

A condition may be bound to a subset of device capability. A condition may be bound to a subset of uplink grants, grant types (e.g., dynamic vs. semi-static/configured grants), a subset of grant indication properties, and/or a property of the grant scheduling indication (e.g., the DCI indication or as a function of the DCI scheduling parameters).

Although features and elements described herein are described in particular combinations, each feature or element may be used alone without the other features and elements of the preferred embodiments, or in various combinations with or without other features and elements.

The description herein may be provided for exemplary purposes and does not limit in any way the applicability of the described systems, methods, and instrumentalities to other wireless technologies and/or to wireless technology using different principles, when applicable. The term network in this disclosure may refer to one or more gNBs which in turn may be associated with one or more Transmission/Reception Points (TRPs) or any other node in the radio access network.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described herein may be implemented in a computer program, software, and/or firmware incorporated in a computer-readable medium for execution by a computer and/or processor Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed:

1. A wireless transmit and receive unit (WTRU) comprising:
a processor configured to:
receive configuration information indicating a plurality of quality of service (QoS) classes, wherein each QoS class in the plurality of QoS classes is associated with a set of transmission parameters;
receive, from higher layers, a data flow comprising a plurality of data units associated with one or more characteristics;
determine a first QoS class in the plurality of QoS classes is associated with the data flow;
determine a first characteristic from the one or more characteristics is associated with a first data unit from the plurality of data units and a second characteristic from the one or more characteristics is associated with a second data unit from the plurality of data units;
determine, based on the first characteristic, the first QoS class is associated with the first data unit;
determine, based on the second characteristic, a second QoS class is associated with the second data unit;
determine, based the first QoS class, a first set of transmission parameters is associated with the first data unit;
determine, based on the second QoS class, a second set of transmission parameters is associated with the second data unit; and
transmit the first and second data units of the data flow, wherein the first data unit is transmitted using the first set of transmission parameters and the second data unit is transmitted using the second set of transmission parameters.

2. The WTRU of claim 1,
wherein the first set of transmission parameters comprise one or more of a priority index, an importance level, a delay bound, a reliability level, a bit rate, or a packet loss rate; and
wherein the second set of transmission parameters comprise one or more of a priority index, an importance level, a delay bound, a reliability level, a bit rate, or a packet loss rate.

3. The WTRU of claim 2,
wherein the first QoS class is associated with a first treatment profile, the first treatment profile comprising the first set of transmission parameters; and
wherein the second QoS class is associated with a second treatment profile, the second treatment profile comprising the second set of transmission parameters.

4. The WTRU of claim 1,
wherein the first QoS class is a default QoS class.

5. The WTRU of claim 4,
wherein the second QoS class is a non-default QoS class.

6. The WTRU of claim 1,
wherein the first characteristic comprises one or more of a priority, an importance, a delay budget, a data type, or dependency on data or events; and
wherein the second characteristic comprises one or more of a priority, an importance, a delay budget, a data type, or dependency on data or events.

7. The WTRU of claim 1,
wherein each of the plurality of data units comprises one of: a bit; a group of bits; a byte; a group of bytes; a PDU segment; a PDU; a group of PDUs; a data burst; or a group of data bursts.

8. The WTRU of claim 1,
wherein the processor configured to determine the second QoS class is associated with the second data unit is further configured to determine the second QoS class is associated with the second data unit for a period of time.

9. A method comprising:
receiving configuration information indicating a plurality of quality of service (QoS) classes, wherein each QoS class in the plurality of QoS classes is associated with a set of transmission parameters;
receiving, from higher layers, a data flow comprising a plurality of data units associated with one or more characteristics;
determining a first QoS class in the plurality of QoS classes is associated with the data flow;
determining a first characteristic from the one or more characteristics is associated with a first data unit from the plurality of data units and a second characteristic from the one or more characteristics is associated with a second data unit from the plurality of data units;
determining, based on the first characteristic, the first QoS class is associated with the first data unit;
determining, based on the second characteristic, a second QoS class is associated with the second data unit;
determining, based the first QoS class, a first set of transmission parameters is associated with the first data unit;
determining, based on the second QoS class, a second set of transmission parameters is associated with the second data unit; and
transmitting the first and second data units of the data flow, wherein the first data unit is transmitted using the first set of transmission parameters and the second data unit is transmitted using the second set of transmission parameters.

10. The method of claim 9,
wherein the first set of transmission parameters comprise one or more of a priority index, an importance level, a delay bound, a reliability level, a bit rate, or a packet loss rate; and
wherein the second set of transmission parameters comprise one or more of a priority index, an importance level, a delay bound, a reliability level, a bit rate, or a packet loss rate.

11. The method of claim 10,
wherein the first QoS class is associated with a first treatment profile, the first treatment profile comprising the first set of transmission parameters; and
wherein the second QoS class is associated with a second treatment profile, the second treatment profile comprising the second set of transmission parameters.

12. The method of claim 9,
wherein the first QoS class is a default QoS class.

13. The method of claim 12,
wherein the second QoS class is a non-default QoS class.

14. The method of claim 9,
wherein the first characteristic comprises one or more of a priority, an importance, a delay budget, a data type, or dependency on data or events; and
wherein the second characteristic comprises one or more of a priority, an importance, a delay budget, a data type, or dependency on data or events.

15. The method of claim 9,
wherein each of the plurality of data units comprises one of: a bit; a group of bits; a byte; a group of bytes; a PDU segment; a PDU; a group of PDUs; a data burst; or a group of data bursts.

16. The method of claim 9,
wherein the processor configured to determine the second QoS class is associated with the second data unit is further configured to determine the second QoS class is associated with the second data unit for a period of time.

17. A wireless transmit and receive unit (WTRU) comprising:
a processor configured to:
receive configuration information indicating a plurality of quality of service (QoS) classes, wherein each QoS class in the plurality of QoS classes is associated with a set of transmission parameters;
receive, from higher layers, a data flow comprising a plurality of data units associated with one or more characteristics;
determine a first QoS class in the plurality of QoS classes is associated with the data flow;
determine a first one or more characteristics from the one or more characteristics is associated with a first data unit from the plurality of data units and a second one or more characteristics from the one or more characteristics is associated with a second data unit from the plurality of data units;
determine, based on the first one or more characteristics, the first QoS class is associated with the first data unit;
determine, based on the second one or more characteristics, a second QoS class is associated with the second data unit;
determine, based the first QoS class, a first set of transmission parameters is associated with the first data unit; and
determine, based on the second QoS class, a second set of transmission parameters is associated with the second data unit.

18. The WTRU of claim 17,
wherein the processor is further configured to:
transmit the first data unit and the second data unit of the data flow, wherein the first data unit is transmitted using the first set of transmission parameters and the second data unit is transmitted using the second set of transmission parameters.

19. The WTRU of claim 18,
wherein the first set of transmission parameters comprises one or more of a priority index, an importance level, a delay bound, a reliability level, a bit rate, or a packet loss rate; and
wherein the second set of transmission parameters comprises one or more of a priority index, an importance level, a delay bound, a reliability level, a bit rate, or a packet loss rate.

20. The WTRU of claim 17,
wherein the first one or more characteristics comprise one or more of a priority, an importance, a delay budget, a data type, or dependency on data or events; and
wherein the second one or more characteristics comprise one or more of a priority, an importance, a delay budget, a data type, or dependency on data or events.
